(19) United States
(12) Patent Application Publication
(10) Pub. No.: US 2017/0147286 A1
(43) Pub. Date: May 25, 2017

(54) METHODS AND SYSTEMS FOR INTERFACING A SPEECH DIALOG WITH NEW APPLICATIONS

(71) Applicant: GM GLOBAL TECHNOLOGY OPERATIONS LLC, Detroit, MI (US)

(72) Inventors: ELI TZIRKEL-HANCOCK, RA'ANANA (IL); TIMOTHY J. GROST, CLARKSTON, MI (US); MICHAL GENUSSOV, TEL AVIV (IL)

(73) Assignee: GM GLOBAL TECHNOLOGY OPERATIONS LLC, Detroit, MI (US)

(21) Appl. No.: 14/947,800

(22) Filed: Nov. 20, 2015

(51) Int. Cl. G06F 3/16

(52) U.S. Cl. CPC G06F 3/167

(57) ABSTRACT

Methods and systems are provided interfacing a speech system with a new application. In one embodiment a method includes: maintaining a registration data datastore that stores registration data from the new application and one or more other applications; receiving, at a router module associated with the speech system, a result from a speech recognition module; processing, by the router module, the result and the registration data to determine a possible new application; and providing the possible new application to the speech system.

### TECHNICAL FIELD

The technical field generally relates to speech systems, and more particularly relates to methods and systems for interfacing a speech dialog of a speech system with new applications.

### BACKGROUND

Generally, speech systems perform speech recognition or understanding of speech uttered by a user or users. The speech utterances typically include commands that communicate with or control one or more features of a system or systems associated with the speech recognition system. In response to the speech utterances, the speech systems typically provide a dialog. The dialog may include responses that are predefined based on the system and/or application of the system that the speech utterance is associated with.

In some instances a system associated with the speech recognition system may include one or more applications that are unknown to the speech system. In such cases, the conventional speech systems are unable to provide a dialog for such unknown applications as the content of such applications are unknown.

Accordingly, it is desirable to provide methods and systems for speech systems to interface with applications that are new to the speech system. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided interfacing a speech system with a new application. In one embodiment a method includes: maintaining a registration data datastore that stores registration data from the new application and one or more other applications; receiving, at a router module associated with the speech system, a result from a speech recognition module; processing, by the router module, the result and the registration data to determine a possible new application; and providing the possible new application to the speech system.

In one embodiment, a speech system includes a registration module that receives and stores registration data from the new application and one or more other applications of one or more sub-systems of the vehicle in a registration data datastore. The speech system further includes a router module that processes, by a processor, a result of speech recognition and the registration data of the registration data datastore to determine a possible new application, and that provides, by the processor, the possible new application to the speech system.

### DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle that includes a speech system in accordance with various exemplary embodiments;

FIG. 2 is a dataflow diagram illustrating a router module of the speech system in accordance with various exemplary embodiments; and

FIGS. 3-5 are sequence diagrams illustrating speech methods that may be performed by the speech system in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

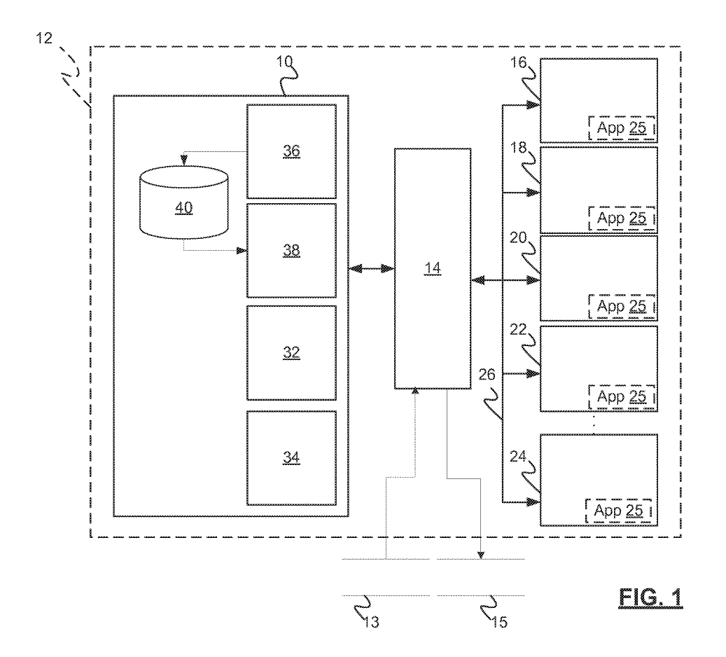

With reference now to FIG. 1, in accordance with exemplary embodiments of the present disclosure a speech system 10 is shown to be included within a vehicle 12. The speech system 10 provides speech recognition capabilities for various sub-systems of the vehicle 12 or systems associated with the vehicle 12. As can be appreciated, the vehicle 12 is merely an example system, as the speech system 10 of the present disclosure can be associated with any speech-dependent systems and is not limited to the present vehicle examples.

In the example of FIG. 1, the speech system 10 provides speech recognition of speech utterances 13 uttered by a user (e.g., a driver or other user) and/or provides a speech dialog 15 to the user through a human machine interface (HMI) module 14. The speech system 10 communicates with one or more sub-systems that are a part of or associated with the vehicle 12 through the HMI module 14. Such sub-systems may include, for example, but are not limited to, a phone system 16, a navigation system 18, a media system 20, a telematics system 22, a network system 24, or any other system that may be a part of or associated with the vehicle 12.

The sub-systems 16-24 may each include one or more applications 25. The applications 25 may be known or unknown by the speech system 10. The applications 25 include software designed to permit a user or system to perform a group of coordinated functions, tasks, or activities. In some instances the functions, tasks, or activities are related to the sub-systems 16-24; and in some instances, the functions, task, or activities are related to other sub-systems. For example, a phone system 16 may include a variety of applications offered by a phone of a phone system 16; and the navigation system 18 may include a variety of navigation applications offered by a navigation system; and so on.

In various embodiments, the speech system 10 communicates with the HMI module 14 and/or the multiple sub-systems 16-24 through a communication bus and/or other communication means 26 (e.g., wired, short range wireless, or long range wireless). The communication bus can be, for example, but is not limited to, a controller area network (CAN) bus, local interconnect network (LIN) bus, or any other type of bus.

In various embodiments, the speech system 10 includes a speech recognition module 32, a dialog manager module 34, a registration module 36, a router module 38, and a registration data datastore 40. As can be appreciated, the speech recognition module 32, the dialog manager module 34, the registration module 36, and the router module 38 may be implemented as separate systems, as combined systems, and/or as a single system as shown. In general, the speech recognition module 32 receives and processes the speech utterances 13 from the HMI module 14 using one or more speech recognition techniques and one or more defined grammars. The speech recognition module 32 generates results of possible recognized speech based on the processing. The dialog manager module 34 manages an interaction sequence and a selection of speech prompts to be presented to the user through the dialog 15 based on the results of the recognition.

The registration module 36 collects registration data from the various applications 25 of the sub-systems 16-24 and stores the registration data in the registration data datastore 40 (e.g., a temporary or a permanent storage device). The registration data includes, but is not limited to, a name of the application, concepts supported by the application, and values associated with the concepts. As can be appreciated, the registration process can occur at scheduled events (e.g., at power up of the vehicle 12, every so many days, or other event) and/or any time a new application is introduced to the vehicle 12.

The router module 38 collects the registration data from the registration data datastore 40 and selectively updates the speech recognition module 32 and/or the dialog manager module 34 with information such that speech recognition and dialog management can be performed for all of the applications 25. The information can include, for example, but is not limited to, a grammar or slots, one or more applications, one or more sub-systems, and/or one or more dialog prompts. By incorporating the registration module 36 and the router module 38 into the speech system 10, the speech system 10 is able to accommodate any unknown applications (e.g., newly added applications or applications unknown at startup).

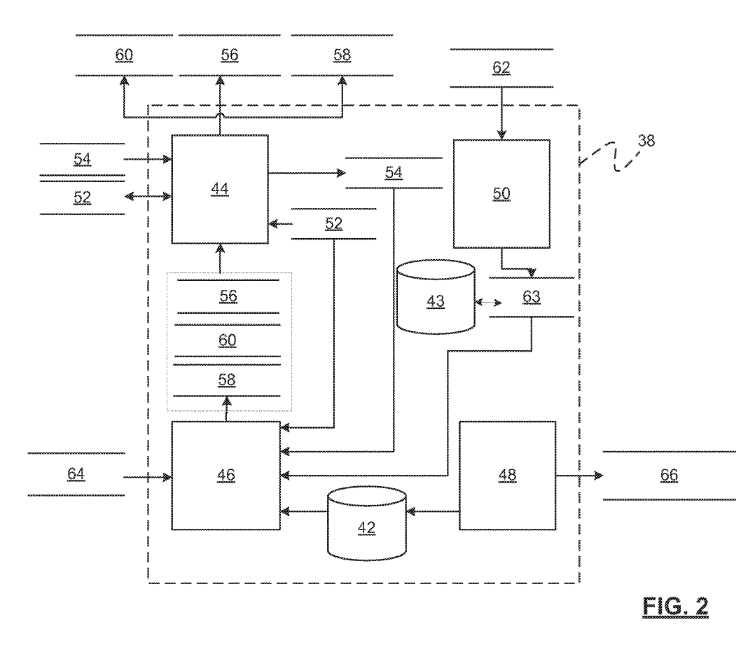

Referring now to FIG. 2 and with continued reference to FIG. 1, a dataflow diagram illustrates the router module 38 in more detail in accordance with various exemplary embodiments. As can be appreciated, various exemplary embodiments of the router module 38, according to the present disclosure, may include any number of sub-modules. As can further be appreciated, the sub-modules shown in FIG. 2 may be combined and/or further partitioned to similarly provide an interface for applications 25 to the speech system 10. In various exemplary embodiments, the router module 38 includes an interface module 44, a classifier module 46, a user model module 48, and a system status module 50.

The interface module 44 interfaces with the speech recognition module 32 and the dialog manager module 34 according to a defined communication protocol. For example, the interface module 44 communicates slots 52 to the dialog manager module 34 or the speech recognition module 32. The slots 52 are concepts or values that are recognizable by the system. The slots 52 can be tagged by the speech recognition module 32 and/or by the dialog manager module 34.

In another example, the interface module 44 receives a one best 54 (or a list of one or more recognized results) from the dialog manager module 34. The one best 54 indicates the one best result of the speech recognition. The one best 54 (or list of one or more recognized results) includes tagged slots that are tagged based on the slots 52. The one best 54 is transmitted by the dialog manager module 34 based on a recognition of the tagged slots.

In still another example, the interface module 44 provides a possible application or applications 56, a sub-system associated with the application 58, and a speech prompt 60 back to the dialog manager module 34. The possible application or applications 56, the sub-system associated with the application 58, and the speech prompt 60 are determined based on the tagged slots in the one best 54 and the registration data as will be discussed in more detail below.

The system status module 50 receives as input systems data 62 from various sub-systems 16-24 or other sub-systems of the vehicle 12. The systems data 62 may indicate a state of the sub-systems and/or of the vehicle 12. The system status module 50 processes the systems data 62 to determine a system status 63 and stores the system status 63 in the systems datastore 43. For example, the systems data 62 can indicate the system is online, or a current location, a current time, or the like, and the system status 63 can be a status that is associated with one or more of the data. The system status module 50 provides the system status 63 to the classifier module 46.

The classifier module 46 receives as input the one best 54 from the interface module 44. The classifier module 46 processes the one best 54 to determine the possible application or applications 56, the sub-system(s) 58 associated with the application(s) 56, and the speech prompt(s) 60. For example, the classifier module 46 receives the system status 63 and retrieves registration data 64 associated with the registered applications that is stored in the registration data datastore 40. The classifier module 46 concepts computes a maximum likelihood probability from tagged slots of the one best 54 based on the concepts and/or values of the registration data 64. The classifier module 46 then retrieves a user model from the user model datastore 42 (if available) and computes a prior probability. The classifier module 46 then computes a final probability using the maximum likelihood probability and the prior probability, for example, by their multiplication. Thereafter, the classifier module 46 generates the possible application or applications 56, the sub-system(s) 58 associated with the application(s) 56, and the speech prompt 60 based on the final probability. For example, the application and associated sub-system with the highest probability is selected and the speech prompts are determined from the registration data for that application.

The user model module 48 receives as input user selection data 66. The user selection data 66 indicates the application 25 and/or sub-system 16-24 selected by the user through the dialog. The user model module 48 updates the user model stored in the user model datastore 42 based on the user selection data 66. The user model may be associated with a particular user of the vehicle 12 or in general any user of the vehicle 12.

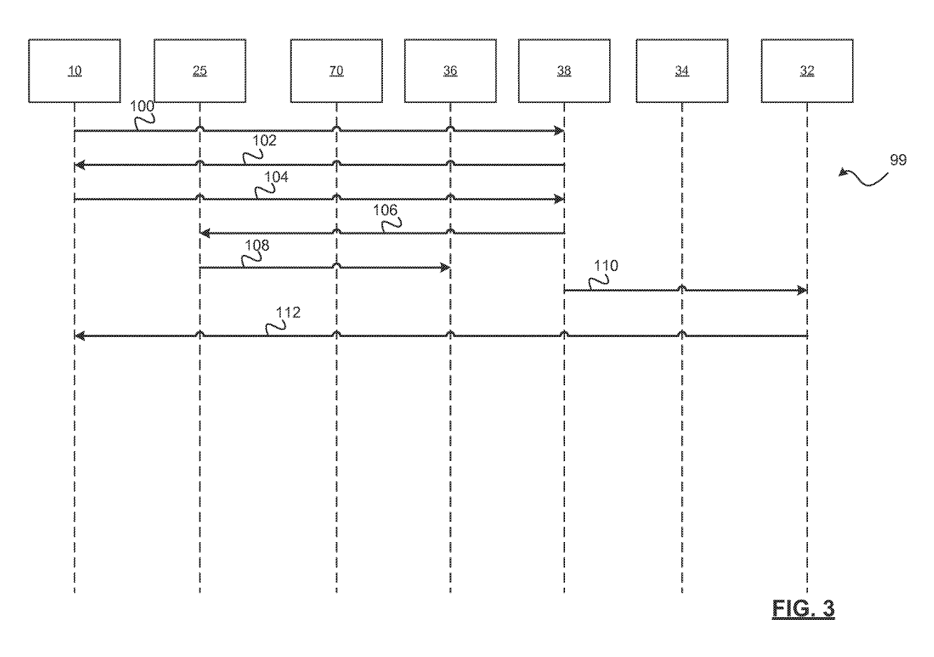

Referring now to FIGS. 3, 4, and 5, and with continued reference to FIGS. 1 and 2, sequence diagrams illustrate methods that may be performed by the speech system 10 in accordance with various exemplary embodiments. As can be appreciated in light of the disclosure, the order of operation within the methods is not limited to the sequential execution as illustrated in FIGS. 3, 4, and 5, but may be performed in one or more varying orders as applicable and in accordance with the present disclosure. As can further be appreciated, one or more steps of the methods may be added or removed without altering the spirit of the method.

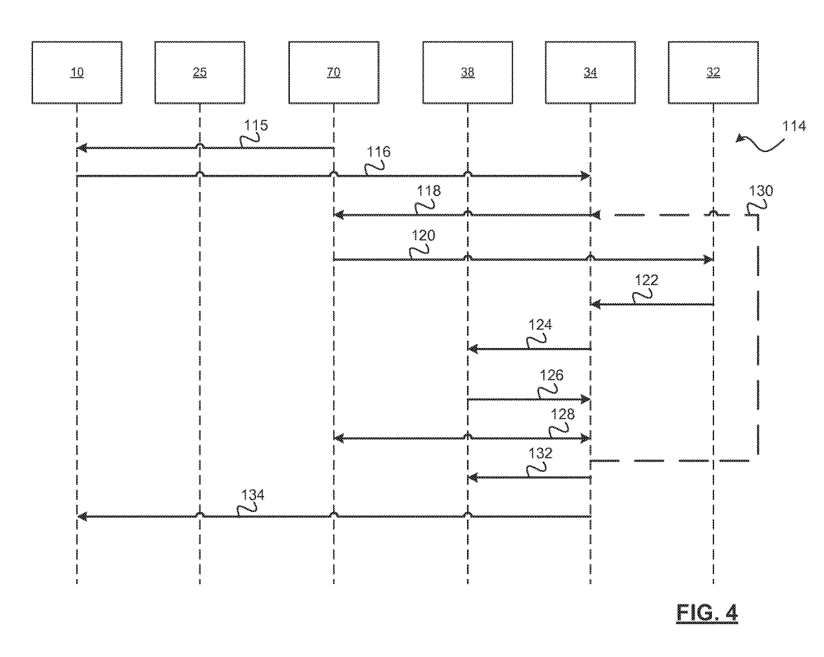

FIGS. 3 and 4 illustrate methods of interfacing with an application 25 by the speech system 10. For example, FIG. 3 illustrates an initialization method 99 that may be performed by the speech system 10; and FIG. 4 illustrates an execution method 114 that may be performed by the speech system 10.

As shown in FIG. 3, in various embodiments, the initialization method may begin at 100 where the system 10 initializes the router module 38. In response, the router module 38 sends a data request to the system 10 at 102. The system 10, in response, provides system data which is stored by the router module 38 at 104. The router module 38 generates a data request to the new application 25 at 106. The new application 25, in response, generates registration data which is received and stored by the registration module 36 at 108. Based on the registration data (e.g., the concepts and the values of the concepts), the router module 38 generates a grammar including slots to be tagged and sends the grammar and slots to the speech recognition module 32 (and/or the dialog manager module 34) at 110. The speech recognition module 32 accepts and stores the grammar and slots and gives control to the system 10 at 112. Thereafter, the initialization is complete.

As shown in FIG. 4, at 115, a user 70 initiates speech by activating the system 10 (e.g., by pressing a talk button, or other feature). In response, the system 10 notifies the dialog manager module 34 to launch the dialog at 116. The dialog manager module 34 generates a prompt that is presented to the user 70 at 118. The user 70, in response, speaks an utterance and the utterance is received by the speech recognition module 32 at 120. Speech recognition is performed on the speech and an N-best list is provided to the dialog manager module 34 at 122. One (or more) result is selected from the N-best list (the one best 54) and based on the tagged slots is presented to the router module 38 at 124. The router module 38 evaluates the one best 54 based on the tagged slots and provides the possible application or applications 56, the sub-system(s) 58 associated with the application(s) 56, and the speech prompt(s) 60 back to the dialog manager module 34 at 126. The speech prompt is presented to the user 70 at 128 and any disambiguation is performed between the user 70 and the dialog manager module 34. Optionally, if the one best 54 was rejected, the method may continue back at 130 where a new prompt is generated by the dialog manager module 34.

If, however, the one best 54 is selected, a notification is sent to the router module 38 to update the user model at 132. Thereafter, control returns to the system 10 at 134.

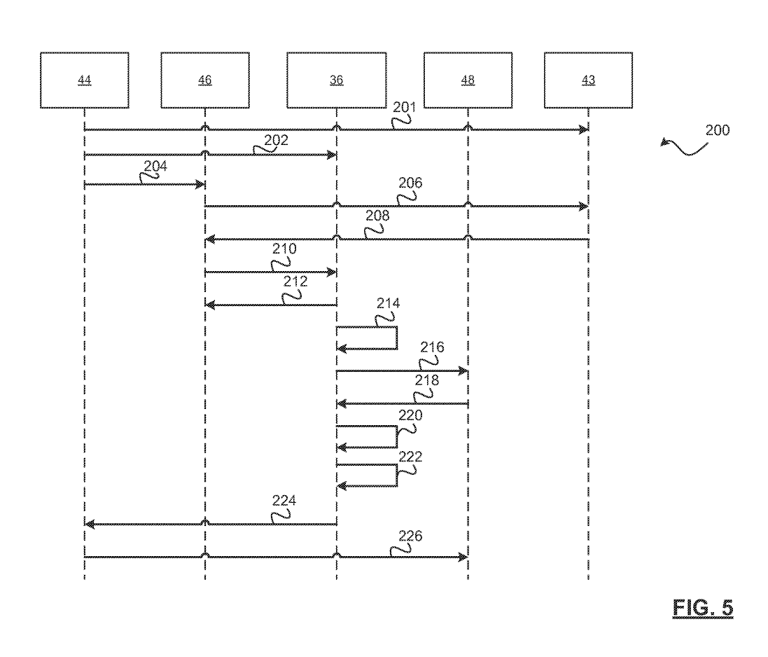

With reference now to FIG. 5, the sequence diagram illustrates a method 200 of processing a new application 54 as performed by the router module 38. In various embodiments, the method may begin, for example, once system data is received from the system 10. The systems data 62 is provided by the interface module 44 to the system status datastore 43 at 201. The registration data is received and stored in the registration datastore at 202. The slots are provided to the classifier module 46 based on the speech recognition at 204. The classifier module 46 then retrieves the system status 63 from the system status datastore 43 and registration data from the registration datastore at 206-212. The maximum-likelihood probability is calculated at 214. Data is requested from the user model datastore at 216. The user model is provided at 218. The prior probability is computed at 220 and the final probability is computed at 222. Thereafter, the final probability is evaluated and the possible application or applications 56, the sub-system(s) 58 associated with the application (s) 56, and the speech prompt(s) 60 is provided to the interface module 44 at 224. Optionally, the user model is updated based on disambiguation at 226. Thereafter, the method may end.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of interfacing a speech system with a new application, comprising:
maintaining a registration data datastore that stores registration data from the new application and one or more other applications;
receiving, at a router module associated with the speech system, a result from a speech recognition module;
processing, by the router module, the result and the registration data to determine a possible new application; and
providing the possible new application to the speech system.

2. The method of claim 1, further comprising:
receiving, at a registration module associated with the speech system, the registration data from the new application; and
storing the received registration data in the registration data datastore, wherein the registration datastore is accessible by the registration module and the router module.

3. The method of claim 1, further comprising:
processing, by the router module, tagged slots of the result and the registration data to determine a possible sub-system associated with the possible new application; and
providing the possible sub-system to the speech system.

4. The method of claim 1, further comprising:
processing, by the router module, tagged slots of the result and the registration data to determine a possible prompt associated with the possible new application; and
providing the possible prompt to the speech system.

5. The method of claim 1, further comprising:
receiving user feedback based on the possible new application; and
updating a user model based on the user feedback.

6. The method of claim 1, further comprising:
receiving system data relating to one or more sub-systems;
processing the system data to determine the system status; and
using the system status to determine the possible new application.

7. The method of claim 1, wherein the processing the registration data and the result comprises determining at least one probability based on a tagged slot of the result and the registration data, and determining the possible new application based on the probability.

8. The method of claim 1, further comprising providing at least one tagged slot to the speech recognition module based on the registration data.

9. The method of claim 1, wherein the registration data includes an application name and at least one concept supported by the application.

10. The method of claim 9, wherein the registration data further includes at least one value associated with the at least one concept.

11. A speech system for interfacing with a new application, comprising:
a registration module that receives and stores registration data from the new application and one or more other applications of one or more sub-systems of the vehicle in a registration data datastore; and
a router module that processes, by a processor, a result of speech recognition and the registration data of the registration data datastore to determine a possible new application, and that provides, by the processor, the possible new application to the speech system.

12. The system of claim 11, wherein router module processes, by the processor, a tagged slot of the result and the registration data to determine a possible sub-system associated with the possible new application, and provides the possible sub-system to the speech system.

13. The system of claim 11, wherein the router module, processes, by the processor, a tagged slot of the result and the registration data to determine a possible prompt associated with the possible new application, and wherein the third non-transitory module provides the possible prompt to the speech system.

14. The system of claim 11, wherein the router module receives, by a processor, user feedback based on the possible new application, and updates a user model based on the user feedback.

15. The system of claim 11, wherein the router module receives, by a processor, system data relating to one or more sub-systems, and processes the system data to determine a system status, and uses the system status to determine the possible new application.

16. The system of claim 11, wherein the router module processes the registration data and the result by determining at least one probability based on the registration data and a tagged slot of the result, and determining the possible new application based on the probability.

17. The system of claim 11, wherein the tagged slot of the result is tagged based on concepts identified in the registration data.

18. The system of claim 11, wherein the registration data includes an application name and at least one concept associated with the application.

19. The system of claim 18, wherein the registration data further includes at least one value associated with the at least one concept.

20. The system of claim 19, wherein the router module provides at least one slot to at least one of a speech recognition module and a dialog manager module based on at least one of the at least one concept and the at least one value.
